(19) United States
(12) Patent Application Publication
(10) Pub. No.: US 2026/0140608 A1
(43) Pub. Date: May 21, 2026

(54) METHOD AND APPARATUS FOR INTERACTION, ELECTRONIC DEVICE AND STORAGE MEDIUM

(71) Applicant: Beijing Zitiao Network Technology Co., Ltd., Beijing (CN)

(72) Inventors: Peihui ZHANG, Beijing (CN); Xiaoxi SUN, Beijing (CN); Jun ZHANG, Beijing (CN)

(21) Appl. No.: 18/705,977

(22) PCT Filed: Sep. 19, 2022
(86) PCT No.: PCT/CN2022/119549

§ 371 Date: Apr. 29, 2024

(30) Foreign Application Priority Data
Oct. 28, 2021 (CN) 202111265329.7

(51) Int. Cl. G06F 3/04845; G06F 3/04817; G06F 3/04842

(52) U.S. Cl. CPC G06F 3/04845; G06F 3/04817; G06F 3/04842

(57) ABSTRACT

Embodiments of the disclosure provide a method and apparatus for interaction, an electronic device, and a storage medium. The method comprises: receiving a sending operation for a target content, the target content comprising at least two predetermined objects; and in response to the sending operation, displaying the target content in a first display region, and displaying a target object corresponding to the at least two predetermined objects in a second display region.

This application claims priority of the Chinese Patent Application No. 202111265329.7, filed with the China National Intellectual Property Administration on Oct. 28, 2021, which is incorporated herein by reference in its entirety.

### FIELD

Embodiments of the present disclosure relate to the field of computer technology, and for example, relate to a method and apparatus for interaction, an electronic device, and a storage medium.

### BACKGROUND

Sticker images or emoji images, as visual representations that abstracts the expression of text, are an indispensable part of today's Internet social life. In the Internet social life, people can input a plurality of sticker images in sequence to represent text words.

However, the sticker interaction method in the related art can display relatively simple content, resulting in a poor user experience.

### SUMMARY

Embodiments of the present disclosure provide a method and apparatus for interaction, an electronic device, and a storage medium, to display diversified information.

Embodiments of the present disclosure provide a method for interaction, comprising:

receiving a sending operation for a target content, the target content comprising at least two predetermined objects; and

in response to the sending operation, displaying the target content in a first display region, and displaying a target object corresponding to the at least two predetermined objects in a second display region.

Embodiments of the present disclosure provide an apparatus for interaction, comprising:

an operation receiving module configured to receive a sending operation for a target content, the target content comprising at least two predetermined objects; and

an object displaying module configured to, in response to the sending operation, display the target content in a first display region and display a target object corresponding to the at least two predetermined objects in a second display region.

Embodiments of the present disclosure provide an electronic device, comprising:

at least one processor; and

a memory configured to store at least one program;

where when the at least one program is executed by the at least one processor, the at least one processor implements the method for interaction according to embodiments of the present disclosure.

Embodiments of the present disclosure provide a computer-readable storage medium having a computer program stored thereon, where when the program is executed by a processor, the method for interaction according to embodiments of the present disclosure.

### BRIEF DESCRIPTION OF THE DRAWINGS

Reference is made to the following embodiments in combination with the drawings. In all the drawings, the same or similar reference signs indicate the same or similar elements. It should be understood that the drawings are schematic, and that components and elements are not necessarily drawn to scale.

FIG. 1 illustrates a schematic flowchart of a method for interaction according to embodiments of the present disclosure;

FIG. 2 illustrates a schematic diagram of a target content according to embodiments of the present disclosure;

FIG. 3 illustrates a schematic diagram of a target object according to embodiments of the present disclosure;

FIG. 4 illustrates a schematic flowchart of a further method for interaction according to embodiments of the present disclosure;

FIG. 5 illustrates a schematic diagram of a moving pattern of a target object according to embodiments of the present disclosure;

FIG. 6 illustrates a schematic diagram showing a display of object prompt information according to embodiments of the present disclosure;

FIG. 7 illustrates a structural block diagram of an apparatus for interaction according to embodiments of the present disclosure; and

FIG. 8 illustrates a schematic structural diagram of an electronic device according to embodiments of the present disclosure.

### DETAILED DESCRIPTION

The embodiments of the present disclosure will be described below with reference to the drawings. Although the drawings illustrate some embodiments of the present disclosure, it should be understood that the present disclosure may be implemented in various forms, and is not limited to the embodiments set forth herein. It should be understood that the drawings and the embodiments of the present disclosure are only used for illustrative purposes and are not intended to limit the protection scope of the present disclosure.

As used herein, term “include” and its variants should be open-ended, i.e., “including but not limited to”. Term “based on” means “based at least in part on”. Term “one embodiment” means “at least one embodiment”; term “another embodiment” means “at least one additional embodiment”; and term “some embodiments” means “at least some embodiments”. Relevant definitions of other terms will be provided in the following text.

It needs to be noted that concepts such as “first”, “second”, and the like mentioned in the present disclosure are only used to distinguish different devices, modules or units, and are not used to limit the order of functions performed by these devices, modules or units, or interdependence relationship.

It should be noted that terms “one” and “multiple” mentioned in the present disclosure are illustrative and not restrictive, and one skilled in the art should understood that the terms should be understood as “one or more” unless the context clearly indicates otherwise.

The names of massages or information exchanged among multiple devices in the embodiments of the present disclosure are only for illustrative purpose, and are not used to limit the range of these messages or the information.

FIG. 1 is a schematic flowchart of a method for interaction according to embodiments of the present disclosure. The method can be performed by an apparatus for interaction, where the apparatus may be implemented in software and/or hardware, and may be embedded in an electronic device, such as a mobile phone or a tablet computer. The method for interaction provided by the embodiments of the present disclosure is suitable for scenarios in which multiple objects sent by users are composed into a new object. As shown in FIG. 1, the method for interaction provided by the present embodiments may comprise the following steps.

S101. Receive a sending operation for a target content, the target content comprising at least two predetermined objects.

The target content may be a content that needs to be sent after being input by the user, such as a comment content, an on-screen comment, a chatting content, or the like. The target content contains at least two predetermined objects, and may also contain content other than the at least two predetermined objects. The at least two predetermined objects included in the target content may be the same or different objects. The predetermined objects may be predetermined characters and/or predetermined sticker images, etc. In the following, the target content being a comment content and the predetermined object being a predetermined sticker image are taken as an example. The sending operation may be understood as an operation of sending the target content, such as an operation of triggering a send control.

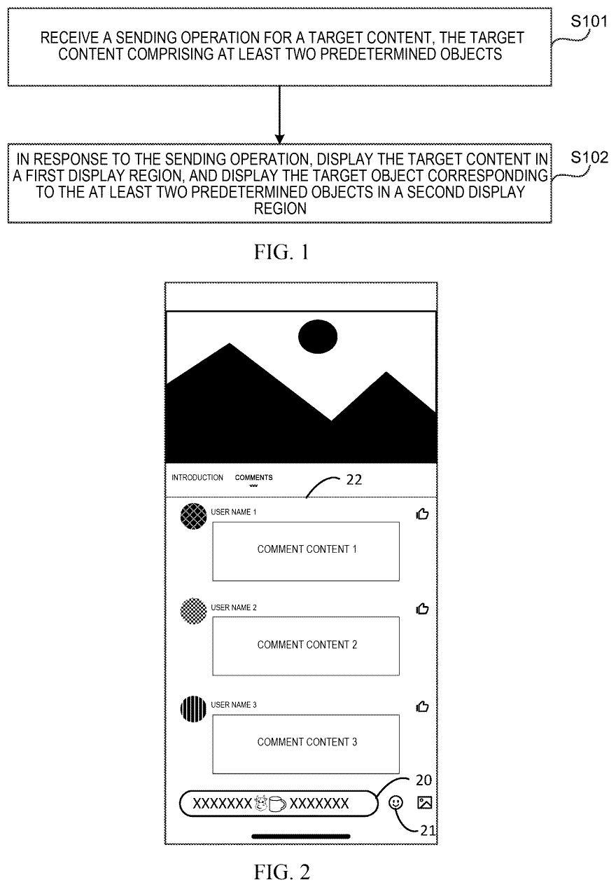

As an example shown in FIG. 2 (where examples of the predetermined objects are a cow sticker image and a beer sticker image), when the user wants to comment on a currently viewed multimedia content (such as a video or an audio), the user may want to comment on the content in an input box 20 and trigger a send control 21 after completing the input. When an electronic device detects that the user triggers the send control 21, the electronic device may obtain the comment content input by the user within the input box 20, and determine whether the comment content contains at least two predetermined objects. If the comment content contains at least two predetermined objects, the electronic device determines the comment content as the target content and detects that the sending operation for the target content is received. If the comment content does not contain at least two predetermined objects, the electronic device may send out the comment in response to the operation of the user triggering the send control, and display the comment content in a comment display region 22 of the multimedia content.

S102. In response to the sending operation, display the target content in a first display region, and display a target object corresponding to the at least two predetermined objects in a second display region.

The first display region may be a content display region. For example, in the case that the target content is a comment content, the first display region may be a comment display region; in the case that the target content is a chatting content, the first display region may be a chatting content display region; in the case that the target content is an on-screen comment content, the first display region may be an on-screen comment display region, and the like. The second display region may be a main display region of the current page. The second display region may comprise the first display region and/or other display regions in the current page except the first display region. The target object may be an sticker image, for example, a new sticker image composed of at least two sticker images. In the case that the at least two predetermined objects included in the target content are characters, each of the at least two predetermined objects may be an sticker image that corresponds to the character corresponding to each predetermined object; and in the case that the at least two predetermined objects included in the target content are sticker images, the at least two predetermined objects may be the at least two sticker images included in the target content.

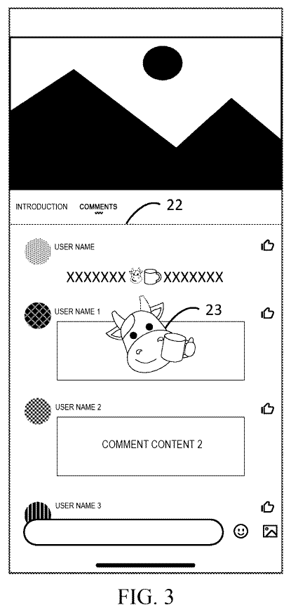

As an example, when receiving the sending operation for the target content, the electronic device may send and display the target content in the first display region 22 of the current page, and display, in the second display region of the current page, a target object 23 which corresponds to the at least two predetermined objects included in the target content. For example, the target object 23 is displayed on the upper layer over the content displayed in the main display region of the current page, as shown in FIG. 3 (which shows an example of a composed image corresponding to the cow sticker image and the beer sticker image included in the targe content).

In the present embodiments, when a triggering operation for the user to send the target content containing at least two predetermined objects is received, in addition to sending the target content and displaying the target content sent by the user in the content display region, the target object corresponding to the at least two predetermined objects is displayed. In other words, when the user sends a content including specific objects, the display of a further object corresponding to the specific objects can be triggered, thereby improving the interest of users when commenting, chatting or sending on-screen comments, and improving the user experience in sending contents.

In the present embodiments, the sequential order of the predetermined objects and/or whether the predetermined objects are consecutive in the target content are not limited, as long as the target content contains at least two predetermined objects (such as predetermined sticker images, or the like), and when receiving a sending operation for the target content by the user, the target content is displayed in the first display region, and the target object corresponding to the at least two predetermined objects is displayed in the second display region. Alternatively, the sequential order of the predetermined objects and/or whether the predetermined objects are consecutive in the target content may be defined, so that only when the target content contains at least two predetermined objects and the at least two predetermined objects are arranged in a predetermined consecutive order in the target content, the subsequent operations are triggered to be performed. Otherwise, if the at least two predetermined objects included in the target content are not arranged in the predetermined order and/or are not arranged in a consecutive order, then in response to the user's sending operation for the target content, the target content is only sent and displayed in the first display region while the target object corresponding to the at least two predetermined objects is not displayed in the second display region. In this way, it can ensure that the target object with the expression is displayed only when the user wants to send an expression represented by a combination of the at least two predetermined objects in the predetermined order, which can avoid too much interference to the user. Optionally, the at least two predetermined objects are arranged sequentially in the target content in a predetermined order, where the at least two predetermined objects may be objects (such as sticker images) with a specific expression when being combined in a predetermined order, and there is an available target object corresponding to the specific expression, This predetermined order may be an arrangement order when the combination of the at least two predetermined objects has the specific expression.

In the present embodiments, when the sending operation for the target content is received, the target object may be displayed in the second display region of the current page, until another page is jumped to from this page or a triggering operation to cease displaying of the target object is received. Alternatively, when a current condition meets a predetermined condition, for example, when a predetermined duration for displaying the target object meets the predetermined condition, the displaying of the target object is ceased so that the user can view the display content below the target object in the current page. Optionally, after displaying the target object corresponding to the at least two predetermined objects in the second display region, the method further comprises: ceasing the displaying of the target object.

In the method for interaction provided by the embodiments of the present disclosure, the sending operation for a target content containing at least two predetermined objects is received; in response to the sending operation, the target content is displayed in a first display region, and a target object corresponding to the at least two predetermined objects is displayed in a second display region. By adopting the above technical solution, the present embodiments can not only display the target content sent by the users, but also display the target object corresponding to the at least two predetermined objects included in the target content. In this way, the present embodiments can enrich the way for interaction and can display more diversified information to the users, meet the user's personalized requirements, and improve the user experience. In addition, by displaying the target object and prompting the user for the target object, it is helpful to increase the utilization rate of the target object by the users.

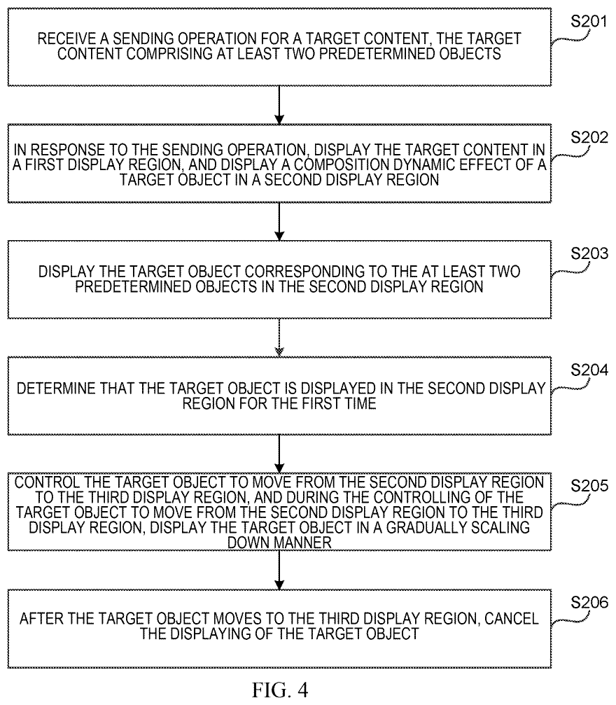

FIG. 4 is a schematic flowchart of a further method for interaction according to embodiments of the present disclosure. The technical solution in the present embodiments may be combined with one or more optional solutions in the above embodiments. Optionally, before displaying the target object corresponding to the at least two predetermined objects in the second display region, the method further comprises: displaying a composition effect of the target object in the second display region.

Optionally, before ceasing the displaying of the target object, the method further comprises: controlling the target object to move from the second display region to a third display region. The ceasing of the displaying of the target object comprises: un-displaying the target object after the target object moves to the third display region.

Optionally, before controlling the target object to move from the second display region to the third display region, the method further comprises: determining that the target object is displayed in the second display region for the first time.

Optionally, the method for interaction provided by the present embodiments further comprises: during the controlling of the target object to move from the second display region to the third display region, displaying the target object in a gradually scaling-down manner.

As shown in FIG. 4, the method for interaction provided by the present embodiments may further comprise the following steps.

S201: Receive a sending operation for a target content, the target content including at least two predetermined objects.

S202: In response to the sending operation, display the target content in the first display region, and display a composition effect of the target object in the second display region.

S203: Display the target object corresponding to the at least two predetermined objects in the second display region.

In the present embodiments, after receiving the sending operation for the target content, the target object corresponding to the target content may not be displayed directly. Instead, the composition effect of the target object may be displayed, and the composed object target is displayed after the displaying of the composition effect is finished. In this way, it can enhance the interest of the displayed information and prompt the user that the target object is a composed object, for example, the target object is a combined sticker image obtained by composing a plurality of sticker images.

When receiving the sending operation for the target content, the electronic device may obtain the target object corresponding to the at least two predetermined objects included in the target content and the composition effect of the target object. The electronic device may send the target content and display the target content in the first display region of the current page. The electronic device may display the composition effect of the target object in the second display region of the current page, and display the composed target object in the second display region after the displaying of the composition effect is finished.

In one embodiment, the at least two predetermined objects and the target object are both sticker images, and displaying the composition effect of the target object in the second display region comprises: displaying, in the second display region, the composition effect of composing the at least two predetermined objects into the target object.

In the above embodiment, when the target content sent by the user comprises at least two predetermined sticker images, the composition effect of composing the at least two predetermined sticker images into a further sticker image may be displayed, so as to prompt the user that the further sticker image is obtained by composing the predetermined sticker images sent by the user.

As an example, when the electronic device receives the sending operation, for example, when it detects that the user triggers a send control, the electronic device may obtain the content to be sent input by the user within the input box and determine whether the content to be sent includes at least two predetermined sticker images that are sequentially arranged in a predetermined order. If the content to be sent includes at least two predetermined sticker images sequentially arranged in a predetermined order, the electronic device sends the target content and displays the target content in the first display region of the current page. The electronic device also displays the composition effect of composing the at least two predetermined sticker images into the target sticker image in the second display region of the current page, and displays the target sticker image in the second display region after the displaying of the composition effect is finished. If the at least two predetermined sticker images included in the content to be sent are not sequentially arranged in a predetermined order, or the content to be sent does not contain the at least two predetermined sticker images, the electronic device sends the target content and displays the target content in the first display region of the current page.

S204. Determine that the target object is displayed in the second display region for the first time.

In the present embodiments, the target object may be controlled in different ways, such as un-displaying the target object in different ways, in the different cases where the user sends the target content containing the at least two predetermined objects corresponding to one target object for the first time, and where the user does not send the target content containing the at least two predetermined objects corresponding to the target object for the first time, i.e., when the user obtains the target object for the first time and when the user does not obtain the target object for the first time.

When determining the target object corresponding to the at least two predetermined objects included in the target content, it is determined whether the user has obtained the target object. If the user has obtained the target object, it can be determined that the target object is not displayed in the second display region for the first time. In this case, when the current condition meets the predetermined condition for un-displaying the target object, for example, when the displaying duration of the target object in the second display region reaches a predetermined duration, the displaying of the target object can be ceased directly. If the user had not yet obtain the target object, it can be determined that the target object is displayed in the second display region for the first time, and the following operations is performed.

S205. Control the target object to move from the second display region to a third display region, and during the controlling of the target object to move from the second display region to the third display region, display the target object in a gradually scaling-down manner.

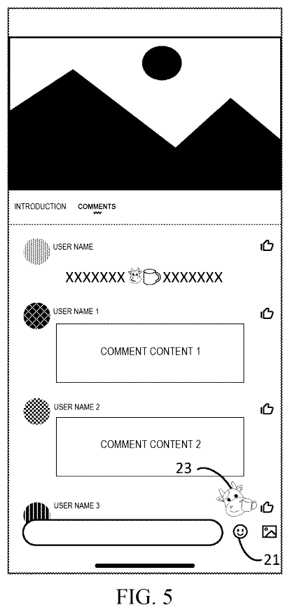

In the present embodiments, when the user obtains the target object for the first time, the target object 23 can be controlled to move to the third display region in a gradually scaling-down manner. For example, when the target object 23 is a new sticker image obtained by the user for the first time, the target object 23 can be controlled to move in a gradually scaling-down manner towards the display region where an sticker control 21 displayed in the current page is located, as shown in FIG. 5. This can present an effect of gathering the target object 23 into the sticker control 21, which can guide the user to view and use the newly obtained target object 23 by triggering the sticker control 21. Here, the third display region may be a display region associated with the target object 23. For example, when the target object 23 is an sticker image, the third display region may be a display region of the sticker control 21; the moving speed and/or moving trajectory of the targe object 23 can be set flexibly as required, which is not limited in the embodiments of the present disclosure.

In one embodiment, after determining that the target object is displayed in the second display region for the first time, the method further comprises: adding the target object to an object panel for the user to send a content comprising the target object.

The object panel can be used to display multiple obtained target objects for the user to view and/or use. When the target object is an sticker image, the object panel may be an sticker panel, and the sticker panel can be displayed when an operation that the user triggers the sticker control is detected.

In the above embodiment, when the user obtains the target object for the first time, the target object can be added into the object panel of the user. As a result, the user can instruct the electronic device to display the object panel by a triggering operation to view the newly obtained target object, and can input the target object into the input box by triggering the target object displayed in the object panel, so as to send a content containing the triggering object. In the case where the object panel is the sticker panel, the newly composed sticker is added to the sticker panel. Thus, the sticker package of the user is enriched, making it easier for the user to use new stickers to send the comment content, chatting content or on-screen comment content, which can improve the user experience.

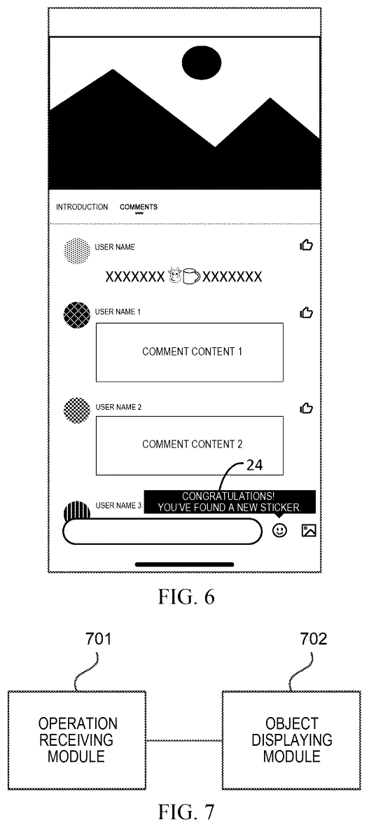

In the above embodiments, as shown in FIG. 6, after it is determined that the target object is displayed in the second display region for the first time, i.e., it is determined that the target object is an object newly obtained by the user, object prompt information 24 can also be displayed to prompt the user that a new object (i.e., the target object) is added into the object panel, which can facilitate the user viewing and using the target object. Optionally, after un-displaying the target object, the method further comprises: displaying object prompt information, where the object prompt information is used to prompt the user that the target object has been added into the object panel.

S206. Undisplay the target object after the target object moves to the third display region.

After the target object moves to the third display region, for example, after the target object moves to the display region where the sticker control 21 in the current page is located, the displaying of the target object can be ceased, to avoid causing interference in viewing other contents in the current page by the user.

In the method for interaction provided by the present embodiments, the composition effect of the target object is displayed; when the user obtains the target object for the first time, the target object is controlled to move from the second display region to the third display region in a gradually scaling-down manner; and when the target object moves to the third display region, the target object is un-displayed and the object prompt information is displayed, which can guide the user to view the newly obtained target object, and improve the user experience.

FIG. 7 is a schematic flowchart of an apparatus for interaction according to embodiments of the present disclosure. The apparatus may be implemented in software and/or hardware, or may be configured in an electronic device, such as a cell phone or a tablet. The apparatus for interaction may interact with the users by performing the method for interaction. As shown in FIG. 7, the apparatus for interaction provided by the embodiments of the present disclosure may include: an operation receiving module 701 configured to receive a sending operation for a target content, the target content comprising at least two predetermined objects; and an object displaying module 702 configured to, in response to the sending operation, display the target content in a first display region and display a target object corresponding to the at least two predetermined objects in a second display region.

In the apparatus for interaction according to embodiments of the present disclosure, receiving, by the operation receiving module, a sending operation for a target content, the target content comprising at least two predetermined objects; and, in response to the sending operation, displaying, by the object displaying module, the target content in a first display region and a target object corresponding to the at least two predetermined objects in a second display region. By adopting the above technical solution, the present embodiments not only display the target content sent by the users, but also display the target object corresponding to the at least two predetermined objects included in the target content. In this way, the present embodiments enrich the way for interaction and can display more diversified information to the users, meet the user's personalized requirements, and improve the user experience. In addition, by displaying the target object and prompting the user for the target object, it is helpful to increase the utilization rate of the target object by the users.

In the above solution, the object displaying module 702 is further configured to, before display the target object corresponding to the at least two predetermined objects in the second display region, display a composition effect of the target object in the second display region.

In the above solution, the at least two predetermined objects and the target object are both sticker images, and the object displaying module 702 is further configured to: display, in the second display region, the composition effect of composing the at least two predetermined objects into the target object.

The apparatus for interaction according to embodiments of the present disclosure also includes a displaying ceasing module configured to, after displaying the target object corresponding to the at least two predetermined objects in the second display region, cease the displaying of the target object.

The apparatus for interaction according to embodiments of the present disclosure also includes a moving control module configured to, before ceasing the displaying of the target object, control the target object to move from the second display region to a third display region; and the displaying ceasing module configured to un-display the target object after the target object moves to the third display region.

The apparatus for interaction according to embodiments of the present disclosure also includes a display determining module configured to, before controlling the target object to move from the second display region to the third display region, determine that the target object is displayed in the second display region for the first time.

The apparatus for interaction according to embodiments of the present disclosure also includes an object adding module configured to, after determining that the target object is displayed in the second display region for the first time, add the target object to an object panel for a user to send a content comprising the target object.

The apparatus for interaction according to embodiments of the present disclosure also includes an information displaying module configured to, after un-displaying the target object, displaying object prompt information, wherein the object prompt information is used to prompt the user that the target object has been added into the object panel.

In the above solution, the moving control module is configured to, during the controlling of the target object to move from the second display region to the third display region, display the target object in a gradually scaling-down manner.

In the above solution, the at least two predetermined objects are arranged sequentially in a predetermined order in the target content.

The apparatus for interaction according to embodiments of the present disclosure may execute the method for interaction according to any embodiment of the present disclosure, and has corresponding functional modules and effects for executing the method for interaction. Technical details not exhaustively described in these embodiments can be found in the method for interaction according to any embodiments of the present disclosure.

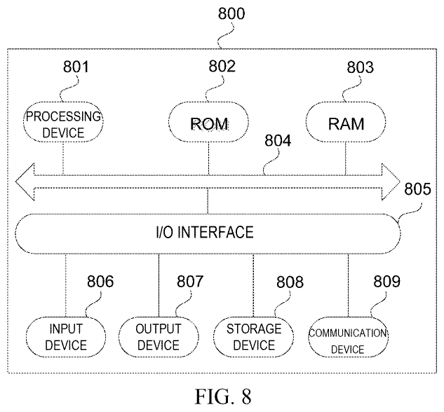

Reference will be made to FIG. 8 below, which illustrates a schematic structural diagram of an electronic device (such as a terminal device) 800 for implementing embodiments of the present disclosure. The terminal devices according to embodiments of the present disclosure may include, but are not limited to, mobile terminals such as mobile phones, notebook computers, digital broadcast receivers, personal digital assistants (PDA), tablet computer PADs, portable medium players (PMP), in-vehicle terminals (e.g., in-vehicle navigation terminals) and so forth, and fixed terminals such as digital TVs, desktop computers and so forth. The electronic device shown in FIG. 8 is only an example and should not impose any limitation on the functions and application scopes of the embodiments of the present disclosure.

As shown in FIG. 8, the electronic device 800 may include a processing device (e.g., a central processor, a graphics processor, etc.) 801. The electronic device 800 may perform various actions and processes based on a program stored in a read-only memory (ROM) 802 or loaded from a storage device 808 into a random access memory (RAM) 803. The RAM 803 further stores various programs and data required for the operation of the electronic device 800. The processing device 801, ROM 802, and RAM 803 are connected to each other via a bus 804. An input/output (I/O) interface 805 is also connected to the bus 804.

Generally, the following devices may be connected to the I/O interface 805: an input device 806 including, for example, a touch screen, a touch pad, a keyboard, a mouse, a camera, a microphone, an accelerometer, a gyroscope, and the like; an output device 807 including, for example, a liquid crystal display (LCD), a loudspeaker, a vibrator, and the like; a storage device 808 including, for example, a magnetic tape, a hard disk, and the like; and a communication device 809. The communication device 809 may allow the electronic device 800 to communicate wirelessly or wiredly with other devices to exchange data. Although FIG. 8 illustrates the electronic device 800 with various devices, it should be understood that it is not required to implement or have all of the illustrated devices; and more or fewer means may alternatively be implemented or provided.

According to embodiments of the present disclosure, the processes described below with reference to the flowcharts may be implemented as a computer software program. For example, embodiments of the present disclosure include a computer program product including a computer program embodied on a non-transient computer-readable medium, and the computer program contains program codes for performing the method shown in the flowchart. In such an embodiment, the computer program may be downloaded and installed from a network via the communication device 809, or installed via the storage device 808, or installed via ROM 802. When the computer program is executed by the processing device 801, the above-mentioned functions defined in the method according to embodiments of the present disclosure are performed.

It should be noted that the computer-readable medium as stated above in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus or device, or any combination thereof. The computer-readable storage medium may include, but is not limited to: an electrical connection with one or more wires, a portable computer disk, a hard disk, RAM, ROM, an erasable programmable read-only memory (EPROM) or a flash memory, an optical fiber, a portable compact disk read-only memory (CD-ROM), an optical storage device, a magnetic storage device, or any combination thereof. In the present disclosure, the computer-readable storage medium may be any tangible medium containing a stored program for use by or in conjunction with an instruction executing system, apparatus, or device. In addition, in the present disclosure, the computer-readable signal medium may include a data signal propagated in a baseband or as a carrier wave, and the computer-readable signal medium carries computer-readable program codes. Such propagated data signals may take a variety of forms, including but not limited to electromagnetic signals, optical signals, or any combination thereof. The computer-readable signal medium may also be any computer-readable medium other than a computer-readable storage medium, and the computer-readable signal medium can send, propagate, or transmit the program for use by or in conjunction with the instruction executing system, apparatus, or device. The program codes included on the computer-readable medium may be transmitted using any medium, including but not limited to wires, optic cables, radio frequency (RF), and the like, or any combination thereof.

In some embodiments, the client, server may communicate utilizing any currently known or future developed network protocol such as Hypertext Transfer Protocol (HTTP), and may be interconnected by any form or medium of digital data communication (e.g., communication networks). Examples of the communication networks include local area networks (LANs), wide area networks (WANs), inter-networks (e.g., the Internet), end-to-end networks (e.g., ad hoc end-to-end networks), and any currently available or future developed networks.

The above-mentioned computer-readable medium may be included in the electronic device above, or may be present alone without being assembled into the electronic device.

The computer-readable medium carries one or more programs, and when the one or more programs are executed by the electronic device, the electronic device performs following steps: receiving a sending operation for a target content, the target content comprising at least two predetermined objects; and in response to the sending operation, displaying the target content in a first display region, and displaying a target object corresponding to the at least two predetermined objects in a second display region.

The computer program codes for performing the operations of the present disclosure may be written in one or more programming languages or combinations thereof. The programming languages include, but are not limited to, object-oriented programming languages such as Java, Smalltalk, and C++, and also include conventional procedural programming languages such as the “C” language or the like. The program codes may be executed entirely on the user's computer, partly on the user's computer, as a stand-alone software package, partly on the user's computer and partly on a remote computer, or entirely on a remote computer or server. In a case of involving a remote computer, the remote computer may be connected to the user's computer through any kind of network including a local area network (LAN) or wide area network (WAN), or may be connected to an external computer (such as through the Internet using an Internet service provider).

The flowcharts and block diagrams in the accompanying drawings illustrate the architecture, functionality, and operation of possible implementations of the system, method, and computer program product according to various embodiments of the present disclosure. Each block in the flowchart or block diagram may represent a module, program segment, or portion of code that contains one or more executable instructions for implementing a prescribed logical function. It shall also be noted that, in some alternative implementations, the functions noted in the blocks may occur in an order different from the order noted in the accompanying drawings. For example, two blocks showed one after the other may actually be executed in parallel, or they may sometimes be executed in the reverse order, depending on the functionality involved. It shall be noted that each block in the block diagram and/or flowchart and the combinations of blocks in the block diagram and/or flowchart, may be implemented with a dedicated hardware-based system that performs the specified functions or operations, or may be implemented with a combination of dedicated hardware and computer instructions.

The units described in embodiments of the present disclosure may be implemented either by means of software or by means of hardware. The name of the module herein is not considered as a limitation to the unit itself.

The functions described above herein may be performed at least in part by one or more hardware logic units. For example, without limitation, example types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, the machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, an electronic, a magnetic, optical, electromagnetic, infrared semiconductor system, apparatus, or device, or any suitable combination thereof. The machine-readable storage medium may include an electrical connection based on one or more wires, a portable computer disk, a hard disk, RAM, ROM, EPROM or flash memory, optical fiber, CD-ROM, optical storage device, magnetic storage device, or any combination thereof.

According to one or more embodiments of the present disclosure, Example 1 provides a method for interaction, comprising: receiving a sending operation for a target content, the target content comprising at least two predetermined objects; and in response to the sending operation, displaying the target content in a first display region, and displaying a target object corresponding to the at least two predetermined objects in a second display region.

According to one or more embodiments of the present disclosure, Example 2 provides the method of Example 1, before displaying the target object corresponding to the at least two predetermined objects in the second display region, the method further comprises: displaying a composition effect of the target object in the second display region.

According to one or more embodiments of the present disclosure, Example 3 provides the method of Example 2, the at least two predetermined objects and the target object are both sticker images, and displaying the composition effect of the target object in the second display region comprises: displaying, in the second display region, the composition effect of composing the at least two predetermined objects into the target object.

According to one or more embodiments of the present disclosure, Example 4 provides the method of Example 1, after displaying the target object corresponding to the at least two predetermined objects in the second display region, the method further comprises: ceasing the displaying of the target object.

According to one or more embodiments of the present disclosure, Example 5 provides the method of Example 4, before ceasing the displaying of the target object, the method further comprises: controlling the target object to move from the second display region to a third display region; and ceasing the displaying of the target object comprises: un-displaying the target object after the target object moves to the third display region.

According to one or more embodiments of the present disclosure, Example 6 provides the method of Example 5, before controlling the target object to move from the second display region to the third display region, the method further comprises: determining that the target object is displayed in the second display region for the first time.

According to one or more embodiments of the present disclosure, Example 7 provides the method of Example 6, after determining that the target object is displayed in the second display region for the first time, the method further comprises: adding the target object to an object panel for a user to send a content comprising the target object.

According to one or more embodiments of the present disclosure, Example 8 provides the method of Example 7, after un-displaying the target object, the method further comprises: displaying object prompt information, wherein the object prompt information is used to prompt the user that the target object has been added into the object panel.

According to one or more embodiments of the present disclosure, Example 9 provides the method of Example 5, further comprising: during the controlling of the target object to move from the second display region to the third display region, displaying the target object in a gradually scaling-down manner.

According to one or more embodiments of the present disclosure, Example 10 provides the method of any of Examples 1 to 9, the at least two predetermined objects are arranged sequentially in a predetermined order in the target content.

According to one or more embodiments of the present disclosure, Example 11 provides an apparatus for interaction, comprising: an operation receiving module configured to receive a sending operation for a target content, the target content comprising at least two predetermined objects; and an object displaying module configured to, in response to the sending operation, display the target content in a first display region and display a target object corresponding to the at least two predetermined objects in a second display region.

According to one or more embodiments of the present disclosure, Example 12 provides an electronic device, comprising: at least one processor; and a memory configured to store at least one program; where when the at least one program is executed by the at least one processor, the at least one processor implements the method for interaction according to any of Examples 1-10.

According to one or more embodiments of the present disclosure, Example 13 provides a computer-readable storage medium having a computer program stored thereon, where when the program is executed by a processor, the method for interaction according to any of Examples 1-10 is implemented.

1. A method for interaction, comprising:
receiving a sending operation for a target content, the target content comprising at least two predetermined objects; and
in response to the sending operation, displaying the target content in a first display region, and displaying a target object corresponding to the at least two predetermined objects in a second display region.

2. The method of claim 1, further comprising: before displaying the target object corresponding to the at least two predetermined objects in the second display region,
displaying a composition effect of the target object in the second display region.

3. The method of claim 2, wherein the at least two predetermined objects and the target object each is a sticker image or an emoji image, and
wherein displaying the composition effect of the target object in the second display region comprises:
displaying, in the second display region, the composition effect of composing the at least two predetermined objects into the target object.

4. The method of claim 1, further comprising:
after displaying the target object corresponding to the at least two predetermined objects in the second display region,
ceasing the displaying of the target object.

5. The method of claim 4, further comprising:
before ceasing the displaying of the target object,
controlling the target object to move from the second display region to a third display region; and
wherein ceasing the displaying of the target object comprises:
ceasing the displaying of the target object after the target object moves to the third display region.

6. The method of claim 5, further comprising: before controlling the target object to move from the second display region to the third display region,
determining that the target object is displayed in the second display region for the first time.

7. The method of claim 6, further comprising: after determining that the target object is displayed in the second display region for the first time,
adding the target object to an object panel for a user to send a content comprising the target object.

8. The method of claim 7, further comprising: after ceasing the displaying of the target object,
displaying object prompt information, wherein the object prompt information is used to prompt the user that the target object has been added into the object panel.

9. The method of claim 5, further comprising:
during the controlling of the target object to move from the second display region to the third display region, displaying the target object in a gradually scaling-down manner.

10. The method of claim 1, wherein the at least two predetermined objects are arranged sequentially in a predetermined order in the target content.

11. (canceled)

12. An electronic device, comprising:
at least one processor; and
a memory configured to store at least one program;
wherein the at least one program, when executed by the at least one processor, causes the at least one processor to perform acts comprising:
receiving a sending operation for a target content, the target content comprising at least two predetermined objects; and
in response to the sending operation, displaying the target content in a first display region, and displaying a target object corresponding to the at least two predetermined objects in a second display region.

13. A non-transitory computer-readable storage medium having a computer program stored thereon, wherein the program, when executed by a processor, causes the processor to perform acts comprising:
receiving a sending operation for a target content, the target content comprising at least two predetermined objects; and
in response to the sending operation, displaying the target content in a first display region, and displaying a target object corresponding to the at least two predetermined objects in a second display region.

14. A method for interaction, comprising:
displaying an object panel, the object panel comprising a plurality of objects;
in response to a trigger on at least two objects among the plurality of objects, selecting the at least two objects; and
in response to a sending operation, displaying a target object corresponding to the at least two objects.

15. The electronic device of claim 12, wherein the acts further comprise: before displaying the target object corresponding to the at least two predetermined objects in the second display region,
displaying a composition effect of the target object in the second display region.

16. The electronic device of claim 13, wherein the at least two predetermined objects and the target object each is a sticker image or an emoji image, and displaying the composition effect of the target object in the second display region comprises:
displaying, in the second display region, the composition effect of composing the at least two predetermined objects into the target object.

17. The electronic device of claim 12, wherein the acts further comprise:
after displaying the target object corresponding to the at least two predetermined objects in the second display region, ceasing the displaying of the target object.

18. The electronic device of claim 17, wherein the acts further comprise:
before ceasing the displaying of the target object, controlling the target object to move from the second display region to a third display region; and
wherein ceasing the displaying of the target object comprises:
ceasing the displaying of the target object after the target object moves to the third display region.

19. The electronic device of claim 18, wherein the acts further comprise: before controlling the target object to move from the second display region to the third display region,
determining that the target object is displayed in the second display region for the first time.

20. The electronic device of claim 19, wherein the acts further comprise: after determining that the target object is displayed in the second display region for the first time,
adding the target object to an object panel for a user to send a content comprising the target object.

21. The electronic device of claim 20, wherein the acts further comprise: after ceasing the displaying of the target object,
displaying object prompt information, wherein the object prompt information is used to prompt the user that the target object has been added into the object panel.
